(19) United States
(12) Patent Application Publication
(10) Pub. No.: US 2011/0017644 A1
(43) Pub. Date: Jan. 27, 2011

(54) Method and System for Separating and Recovering Like-Type Materials from an Electronic Waste System

(76) Inventor: Thomas A. Valerio, New Port Richey, FL (US)

Correspondence Address: KING & SPALDING, 1180 PEACHTREE STREET , NE, ATLANTA, GA, 30309-3521, US

(21) Appl. No.: 12/840,853

(22) Filed: Jul. 21, 2010

Related U.S. Application Data
(60) Provisional application No. 61/227,385, filed on Jul. 21, 2009.

(51) Int. Cl. B07C 5/00; B07B 15/00; B03C 1/30

(52) U.S. Cl. 209/38; 209/44.1; 209/39

(57) ABSTRACT

Recovering like-type materials from an electronic waste stream. The recovered materials can include, without limitation, ferrous and non-ferrous metals and plastics. Also, printed circuit board materials and precious metals can be recovered. Distinct technologies are combined to achieve the separation of the unique materials.

### RELATED APPLICATIONS

This non-provisional patent application claims priority under 35 U.S.C. §119 to U.S. Provisional Patent Application No. 61/227,385, titled “Method and System for Separating and Recovering Like-Type Materials from an Electronic Waste Stream,” filed Jul. 21, 2009, the complete disclosure of which is hereby fully incorporated herein by reference.

### TECHNICAL FIELD

The present disclosure relates generally to processing of recycled materials, and more particularly, to systems and methods for separating and recovering like-type materials, including metals and plastics, from an electronic waste stream.

### BACKGROUND

Recycling of waste materials is highly desirable from many viewpoints, not the least of which are financial and ecological. Properly sorted recyclable materials can often be sold for significant revenue. Many of the more valuable recyclable materials do not biodegrade within a short period. Recycling of those materials significantly reduces the strain on local landfills and ultimately the environment.

Typically, waste streams are composed of a variety of types of waste materials. One such waste stream is generated from the recovery and recycling of automobiles or other large machinery and appliances. For example, at the end of its useful life, an automobile is shredded. This shredded material is processed to recover ferrous and non-ferrous metals. The remaining materials that are not recovered are referred to as automobile shredder residue (“ASR”). The ASR, which may still include ferrous and non-ferrous metals, including copper wire and other recyclable materials, is typically disposed of in a landfill.

Recently, efforts have been made to further recover materials, such as plastics and copper and other non-ferrous metals, from ASR. Similar efforts have been made to recover materials from whitegood shredder residue (WSR), which includes the waste materials left over after recovering ferrous metals from shredded machinery or large appliances. Other waste streams that have recoverable materials include electronic components (also known as “e-waste” or “waste electrical and electronic equipment” (“WEEE”)), building components, retrieved landfill material, and other industrial waste streams.

These recoverable materials are generally of value only when they have been separated into like-type materials. However, in many instances, no cost-effective methods are available to effectively sort waste materials that contain diverse materials. This deficiency has been particularly true for non-ferrous materials, and especially for non-ferrous metals, including copper wiring. While certain aspects of ferrous and non-ferrous recycling has been automated for some time, mainly through the use of magnets, eddy current separators, induction sensors, and density separators, these techniques are ineffective for sorting some non-ferrous metals, such as copper wire.

Traditionally, only labor-intensive manual processing has successfully been employed to recover wiring and other non-ferrous metal materials. For example, one conventional approach to recycling wiring has been to station a number of laborers along a sorting line, with each laborer manually sorting through shredded waste and selecting desired recyclables from the sorting line. This approach is not sustainable in most economies because the labor cost is too high. In some cases, manual processes such as this can be conducted in other countries that have lower labor costs than in the United States. However, transporting the materials to and from those other countries can be prohibitively expensive.

In view of the foregoing, a need exists for cost-effective, efficient methods and systems for recovering materials from a waste stream. In particular, a need exists for systems and methods for separating and recovering like-type materials, including metals and plastics, from an electronic waste stream in a manner that facilitates revenue recovery while also reducing landfill.

### SUMMARY OF THE INVENTION

The invention is directed to cost-effective, efficient methods and systems for recovering materials from a waste stream. In particular, the invention is directed to systems and methods for separating and recovering like-type materials from an electronic waste stream. The recovered materials can include, without limitation, ferrous and non-ferrous metals and plastics.

One aspect of the present invention provides a method for separating materials from an electronic waste stream. The method includes the steps of: 1) receiving the electronic waste stream comprising ferrous and non-ferrous material; 2) separating the received electronic waste stream into a ferrous material fraction comprising at least a portion of the ferrous material and a non-ferrous material fraction comprising at least a portion of the non-ferrous material by removing the ferrous material fraction using the magnetic characteristic of the ferrous material comprising the ferrous material fraction; 3) further separating the non-ferrous material into a non-ferrous metal fraction and an other non-ferrous material fraction using an eddy current separator; and 4) recovering a zorba material from the non-ferrous metal fraction by separating a printed circuit board material from the non-ferrous metal fraction using an optical sorter.

Another aspect of the present invention provides a method for separating materials from an electronic waste stream. This method includes the steps of: 1) receiving the electronic waste stream comprising ferrous and non-ferrous material; 2) separating the received electronic waste stream into a ferrous material fraction comprising at least a portion of the ferrous material and a non-ferrous material fraction comprising at least a portion of the non-ferrous material by removing the ferrous material fraction using the magnetic characteristic of the ferrous material comprising the ferrous material fraction; 3) further separating the ferrous material into a heavy fraction and light fraction using an air separator; and recovering any precious metal from the light fraction.

Yet another aspect of the present invention provides a system for separating materials from an electronic waste stream material. The system includes 1) a size reducer operable to reduce the size of the electronic waste stream material; 2) a ferrous material separator, operable to separate ferrous material from the size-reduced electronic waste stream material, resulting in a ferrous material fraction and a non-ferrous material fraction; 3) an air separator operable to separate the ferrous material fraction into a light fraction and a heavy fraction; and 4) a cyclone operable to separate precious metal from the light fraction.

### BRIEF DESCRIPTION OF THE DRAWINGS

For a more complete understanding of the invention and the advantages thereof, reference is now made to the following description, in conjunction with the accompanying figures briefly described as follows.

FIG. 1a is a block diagram depicting a first segment of a system for separating and recovering like-type materials from an electronic waste stream, in accordance with certain exemplary embodiments.

FIG. 1b is a block diagram depicting a second segment of a system for separating and recovering like-type materials from an electronic waste stream, in accordance with certain exemplary embodiments.

FIG. 1c is a block diagram depicting a third segment of a system for separating and recovering like-type materials from an electronic waste stream, in accordance with certain exemplary embodiments.

FIG. 2a is a first segment of a flow chart depicting a method for separating and recovering like-type materials from an electronic waste stream, in accordance with certain exemplary embodiments.

FIG. 2b is a second segment of a flow chart depicting a method for separating and recovering like-type materials from an electronic waste stream, in accordance with certain exemplary embodiments.

FIG. 3 is a flow chart depicting an alternative method for processing non-ferrous materials, in accordance with certain exemplary embodiments.

### DETAILED DESCRIPTION OF THE EXEMPLARY EMBODIMENTS

The invention is directed to cost-effective, efficient methods and systems for recovering materials from a waste stream. In particular, the invention is directed to systems and methods for separating and recovering like-type materials from an electronic waste stream. The recovered materials can include, without limitation, ferrous and non-ferrous metals and plastics.

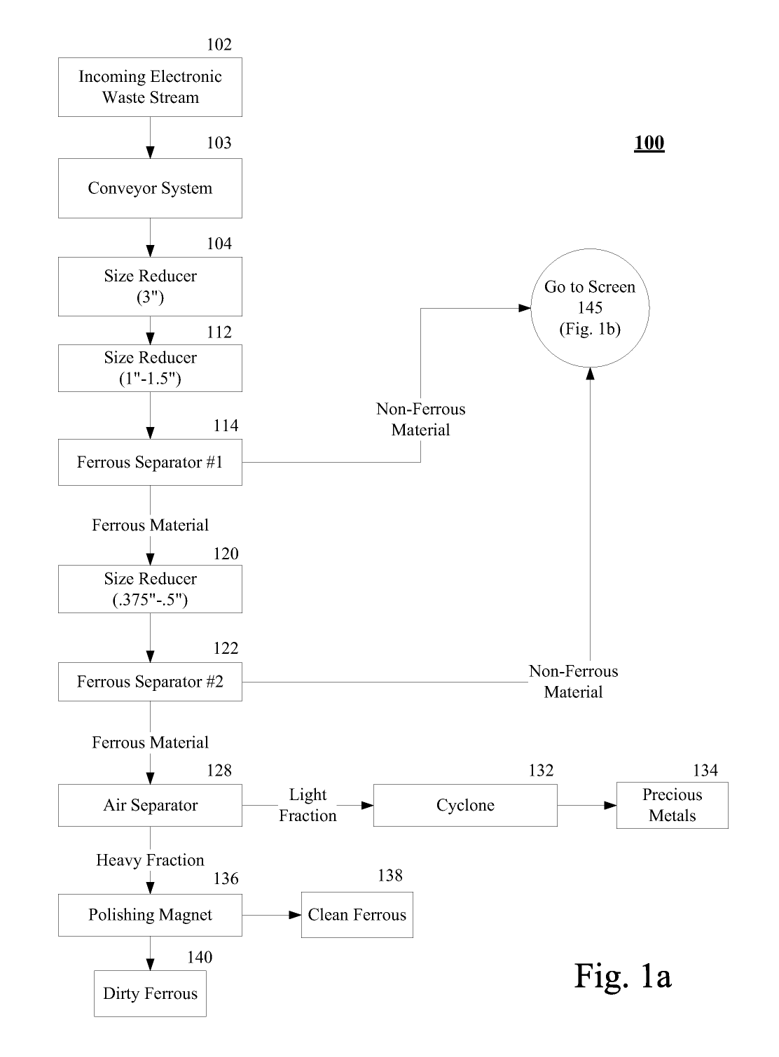

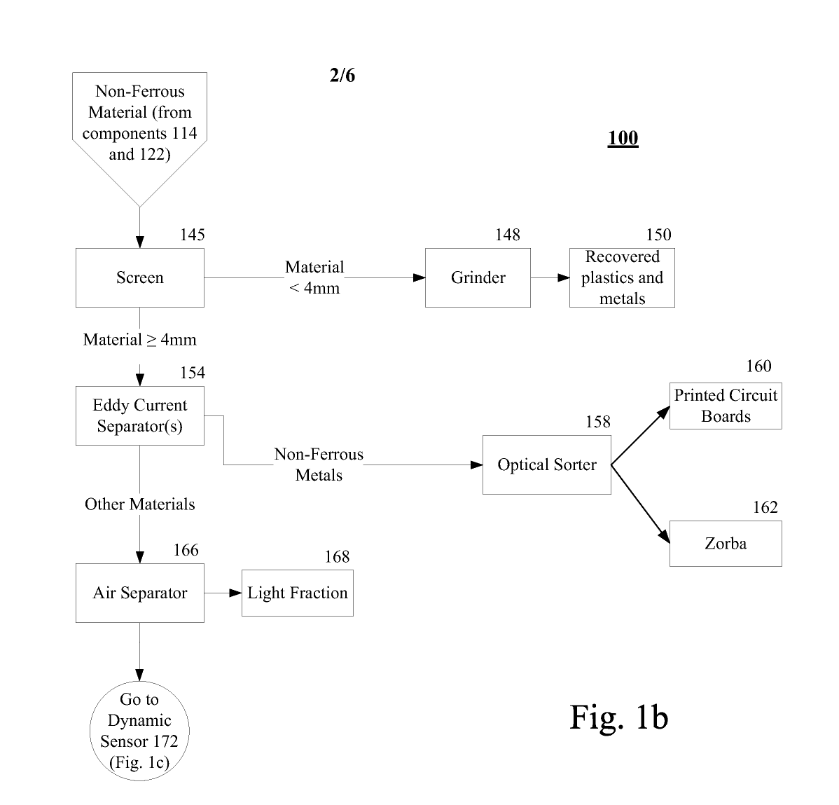

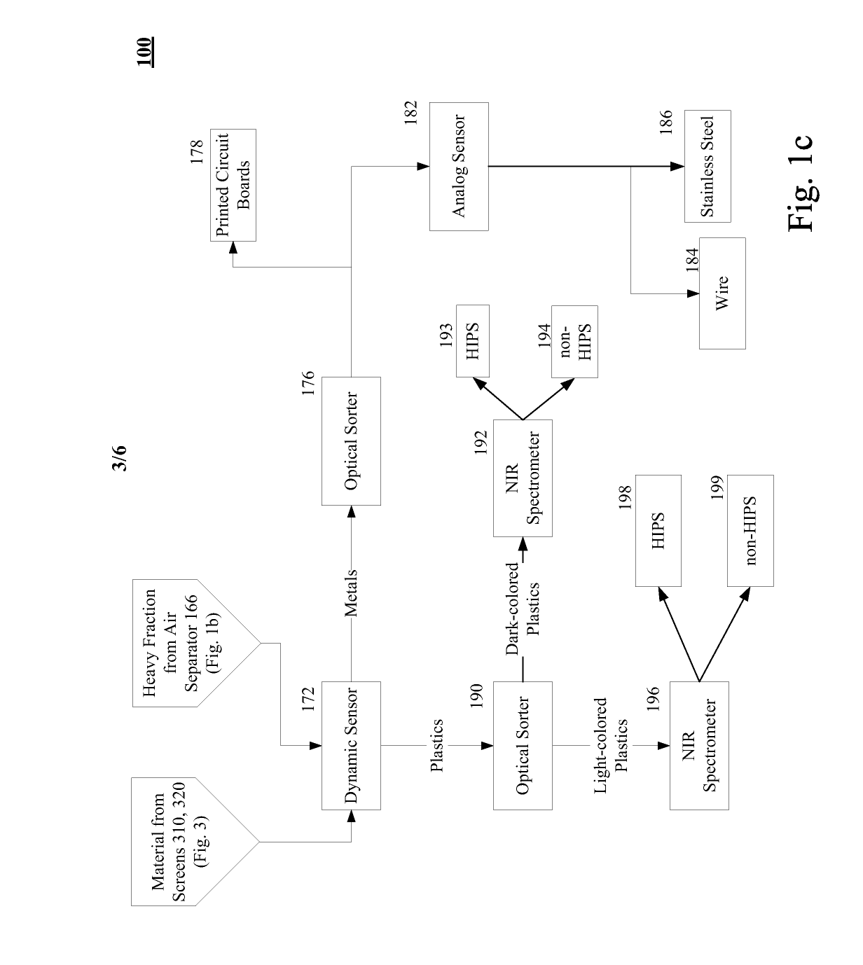

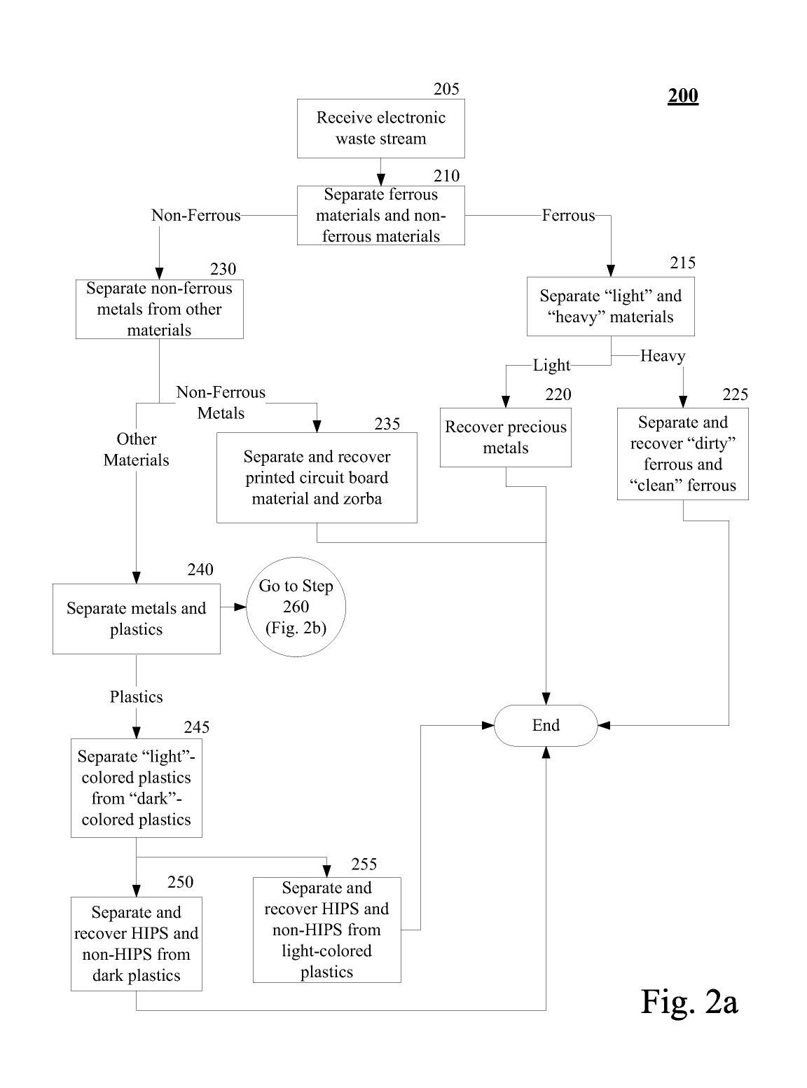

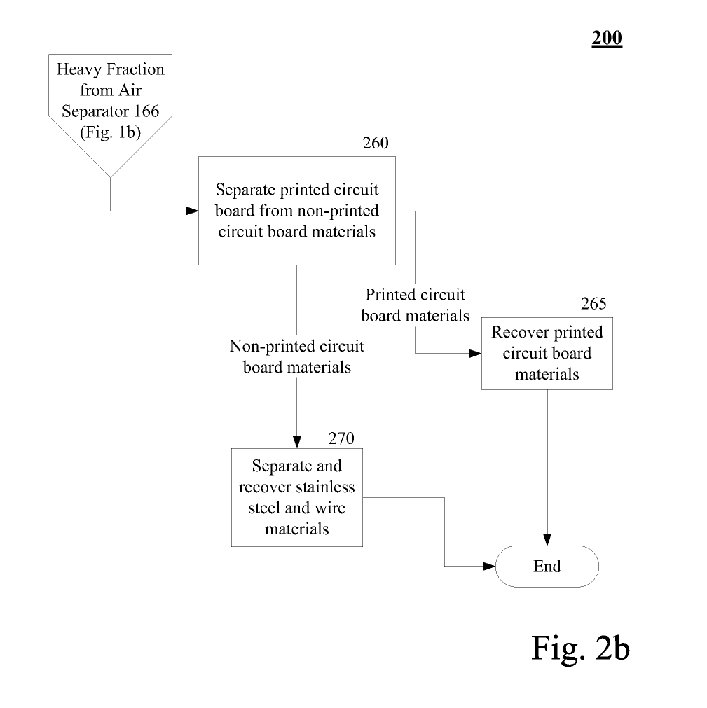

Turning now to the drawings, in which like numerals indicate like elements throughout the figures, exemplary embodiments of the invention are described in detail. FIGS. 1a, 1b, and 1c represent three segments of a block diagram depicting a system 100 for separating and recovering like-type materials from an electronic waste stream 102, in accordance with certain exemplary embodiments. The system 100 is described hereinafter with reference to a method 200 illustrated in FIG. 2, which is depicted in two segments in FIGS. 2a and 2b. FIGS. 2a and 2b form a flow chart depicting the method 200 for separating and recovering like-type materials from an electronic waste stream, in accordance with certain exemplary embodiments. The exemplary method 200 is illustrative and, in alternative embodiments of the invention, certain steps can be performed in a different order, in parallel with one another, or omitted entirely, and/or certain additional steps can be performed without departing from the scope and spirit of the invention. The method 200 is described hereinafter with reference to FIGS. 1a, 1b, 1c, 2a, and 2b.

In step 205, an electronic waste stream 102 is received. The electronic waste stream 102 includes scrap materials that may or may not have already been processed in accordance with a primary recycle and recovery effort. For example, the electronic waste stream 102 may include materials left over from prior processing of ASR, WSR, and/or WEEE. The method 200 may be used to recover (or further recover) materials from the electronic waste stream 102, thereby reducing the amount of waste materials left in a landfill or other location. Although depicted in FIG. 1 as being transported and received by a conveyor belt 103, the electronic waste stream 102 can be transported and received by any of a variety of mechanisms, including, without limitation, conveyor belts, slides, chutes, screw conveyors, augers, and the like.

In step 210, ferrous materials and non-ferrous materials in the electronic waste 102 are separated using a series of size reducers 104, 112, and 120, and ferrous separators 114 and 122. In certain exemplary embodiments, the electronic waste stream 102 passes through a first size reducer 104, which segregates the electronic waste stream 102 into segments of a pre-determined size. For example, the first size reducer 104 can cut and/or separate the electronic waste stream 102 into segments that are no greater than three inches in size. Then, the materials can be further reduced in size by a second size reducer 112, which reduces the materials into segments that are no greater than 1″-1.5″ in size. Each of the size reducers 104 and 112 can include any device operable to cut and/or separate waste materials, including, without limitation, a slow-speed shredder, pre-chopper, hammer mill, ring mill, or the like.

As part of step 210, the first ferrous separator 114 receives the reduced-sized materials from the second size reducer 112 and segregates ferrous materials and non-ferrous materials therein for further processing. The first ferrous separator 114 can include any device capable of detecting or identifying ferrous materials, including, without limitation, a belt or plate magnet separator, a pulley magnet, and/or a drum magnet. In certain exemplary embodiments, the first ferrous separator 114 can include multiple drum magnets separated by a shaker feeder, which separates the material for easier processing by the drum magnets. The non-ferrous materials continue to the screen 145 for further processing, as described below in connection with step 230. The ferrous materials continue to a third size reducer 120, which further reduces the size of the ferrous materials. For example, the third size reducer 120 can cut and/or separate the ferrous materials into segments having a size of 0.375 inches to 0.5 inches. Like the first and second size reducers 104 and 112, the third size reducer 120 can include any device operable to cut and/or separate waste materials, including, without limitation, a slow-speed shredder, pre-chopper, hammer mill, ring mill, or the like.

Also as part of step 210, a second ferrous separator 122 receives the reduced-sized materials from the third size reducer 120 and segregates ferrous materials and non-ferrous materials therein for further processing. Like the first ferrous separator 114, the second ferrous separator 122 can include any device capable of detecting or identifying ferrous materials, including, without limitation, a belt or plate magnet separator, a pulley magnet, and/or a drum magnet. In certain exemplary embodiments, the second ferrous separator 122 can include multiple drum magnets separated by a shaker feeder, which separates the material for easier processing by the drum magnets. The non-ferrous materials continue to the screen 145 for further processing, as described below in connection with step 230. Although described as “non-ferrous” material and “ferrous” material, neither separated stream will be 100 percent “ferrous” or “non-ferrous.” Instead, these terms are used to define the predominant characteristic of the material. Accordingly, the “non-ferrous” material will include a fraction of ferrous materials and the “ferrous” material will include a fraction of non-ferrous materials.

In step 215, an air separator (or aspiration system) 128 segregates the ferrous material into a “light” fraction and a “heavy” fraction. The air separator is a device, which is operable for using air to segregate lighter materials and heavier materials. For example, the air separator can include a “Z-box.” As its name implies, a Z-box is a Z-shaped box. Dry material is added at the top of the Z-box and falls by gravity. Air is forced up through the falling material. Lighter material would be entrained in the air while heavy material would fall out, as the force of the air is insufficient to overcome the gravity of the heavy material. The “Z” shape forces the falling material to impact walls of the chamber, thus releasing lighter materials that may be combined with heavier materials, improving the separation of heavy and light materials. Of course, other air separator systems can be used. Another such air separator is described in U.S. patent application Ser. No. 12/769,525, entitled “Apparatus and Method for Separating Materials Using Air, which is hereby incorporated by reference herein in its entirety.

In step 220, a cyclone 132 processes the light fraction from the air separator 128 to recover any precious metals 134 therein. For example, the light fraction may include trace amounts of platinum, silver, and other precious metals 134 from computer chip boards and the like in the electronic waste stream 102. The cyclone 132 is a device, which is operable to remove particulates from an air, gas, or fluid stream through vortex separation. For example, a high speed rotating air flow within the cyclone 132 can cause particulates, such as trace amounts of precious metals 134, in the light fraction 130 to strike an outside wall of the cyclone 132 and fall to a bottom of the cyclone 132, to be recovered. In another example, the particulates can be entrained in a fluid, such as water. In this case, the cyclone 132 would be a “hydrocyclone.”

In step 225, a polishing magnet 136 processes the heavy fraction to separate and recover “clean” ferrous material 138 and “dirty” ferrous metal 140. Clean ferrous material 138 is ferrous material that is substantially devoid of copper-bearing materials. Dirty ferrous material 140 includes any material that is not clean ferrous 138, including, without limitation, copper-bearing materials.

The polishing magnet 136 includes a magnet, which can be used to distinguish between clean ferrous 138 and dirty ferrous 140 materials (in the heavy fraction) based on the duration and strength of magnetism between the magnet and the materials. Copper has a relatively weak magnetic field as compared to other ferrous metals. Therefore, it can be expected that there will be a lesser degree and duration of magnetism between the magnet and the dirty ferrous materials 140 than there will be between the magnet and the clean ferrous materials 135. The polishing magnet 136 can use this distinction to segregate the clean ferrous materials 135 (with relatively long degrees and durations of magnetism) from the dirty ferrous materials 140 (with relatively short degrees and durations of magnetism). For example, the polishing magnet 136 can release the dirty ferrous materials 140 and the clean ferrous materials 135 at different locations and/or different times that correspond to their respective durations of magnetism.

In step 230, the non-ferrous materials separated in step 210 are processed to further separate non-ferrous metals from other materials. The non-ferrous materials are sorted through a screen 145, which segregates the materials into smaller materials (such as materials that are less than 4 millimeters in size) and larger materials (such as materials that are greater than or equal to 4 millimeters in size). In certain exemplary embodiments, the smaller materials pass through a grinder 148, which further reduces the size of those materials to liberate, and allow for the recovery of, any metals and/or plastics 150 therein.

An eddy current separator 154 processes the larger materials (greater than or equal to than 4 millimeters in size) to separate non-ferrous metals from other materials. The eddy current separator 154 includes a rotor that includes magnet blocks. The magnet blocks can include standard ferrite ceramic magnets and/or powerful, rare earth magnets. The rotor spins at high revolutions (over 3000 rpm) to produce an “eddy current.” The eddy current reacts with different metals according to their specific mass and resistivity, creating a repelling force on the charged particles of the material. If a metal is light yet conductive, as is the case with aluminum, it is easily levitated and ejected from the normal flow of the product stream, making separation possible. Separation of stainless steel is also possible depending on the grade of the material. Eddy current separation is less effective for particle sizes less than 2 millimeters in diameter.

In certain alternative exemplary embodiments, the screen 145 can include two or more screens, which segregate the materials into three or more groups based on the size of the materials. For example, the screen 145 can segregate the non-ferrous materials into (a) materials having a size less than 4 millimeters, (b) materials having a size between 4 millimeters and 18 millimeters (“mid-sized materials”), and (c) materials having a size greater than 18 millimeters (“largest-sized materials”). Different eddy current separators can process the mid-sized materials and the largest-sized materials. For example, a larger-sized eddy current separator 154 (having a width of 60 inches) can process the largest-sized materials, and a smaller-sized eddy current separator 154 (having a width of 40 inches) can process the mid-sized materials.

Although step 230 separates non-ferrous materials into “non-ferrous metals” and “other materials,” the “non-ferrous metals” will include a fraction of material that are not non-ferrous metals. Similarly, the “other materials,” will include a fraction of non-ferrous metals.

In step 235, an optical sorter 158 processes the non-ferrous metals (that were separated by the eddy current separator 154 in step 230) to separate and recover printed circuit board materials 160 and zorba 162. Zorba is a concentrate of non-ferrous metals. Zorba may be referred to as zorba #, where “#” represents the percentage of non-ferrous metals in the concentrate. So, zorba 90 would have 90 percent non-ferrous metals and zorba 67 would have 67 percent non-ferrous metals. Printed circuit board materials are typically 30 percent metals. The printed circuit board materials 160 can be segregated from other components in the electronic waste stream 105 and further processed to recover these metals.

The optical sorter 158 includes one or more optical devices, such as cameras, which are operable to detect the color of a material. In certain exemplary embodiments, the optical sorter 158 identifies green materials in the non-ferrous metals 156 as printed circuit board materials 160 and non-green materials in the non-ferrous metals 156 as zorba 162, as printed circuit boards are typically green in color. Of course, if the printed circuit boards being processed are of a different color, the optical sorter 158 can be calibrated to this different color. The recovered zorba 162 may be processed in accordance with known processes to identify any precious metals therein.

The optical sorter 158 may include an optical camera connected to a computer, which captures images of a waste stream. These images may be captured as material moves past the optical sorter 158 on a conveyance, such as a conveyor belt. Alternatively, images may be captured from a batch of material. The optical camera works like a normal camera, which captures images based on visible light. The images are sent to a computer, which analyzes the image. In this case, the computer determines what parts of the image have a green color. These green portions of the image identify locations of printed circuit board materials 160. If the material is moving along a conveyance, the computer may then actuate a sorter, such as an air jet, to selectively sort out the printed circuit board materials 160 identified from the image.

In step 240, a dynamic sensor 172 segregates the other materials (that were separated by the eddy current separator 154 in step 230) into a group of plastic materials and a group of metal materials. In certain exemplary embodiments, this step 240 involves a pre-processing step of separating the other materials into a heavy fraction and a light fraction using an air separator, substantially as described above in connection with step 215, with only the heavy fraction being processed by the dynamic sensor 172.

The dynamic sensor 172 is a device that measures the rate of change of the amount of current produced in an inductive loop and detects the presence of metallic objects based on the measured rate of change. The rate of change of the current is determined as rise in current per unit time. When the dynamic sensor senses a change in the current of a minimum amount (differential) over a certain amount of time (rise time), it turns on its digital output for a specified interval (pulse time). In other words, the dynamic sensor indicates the presence of a metallic object in the material stream being measured 164 when the rate of change of the current in the inductive loop exceeds a threshold. Certain exemplary dynamic sensors 172 are described in more detail in U.S. Pat. No. 7,732,726, entitled “System and Method for Sorting Dissimilar Materials Using a Dynamic Sensor,” issued Jun. 8, 2010, the entire content of which is hereby fully incorporated herein by reference.

In step 245, an optical sorter 190 processes the plastics detected by the dynamic sensor 172 in step 240 to separate light-colored plastics and dark-colored plastics. Like the optical sorter 158, the optical sorter 190 includes one or more optical devices, such as cameras, which are operable to detect the color of a material. For example, the optical sorter 190 can identify white or other light-colored items as “light-colored” plastics and all other items as dark-colored plastics. A computer would analyze the image captured by the camera and identify light-colored areas and dark-colored areas. These identified areas would represent the different materials to be separated. If the material is moving along a conveyance, the computer may then actuate a sorter, such as an air jet, to selectively sort out one of the colors (for example, the light-colored plastics) identified from the image, with the dark-colored plastics continuing to move down the conveyance.

In step 250, a near infrared (“NIR”) spectrometer 192 processes the dark-colored plastics to separate and recover high impact polystyrene plastics (“HIPS”) 193 from non-HIPS materials 194, such as acrylonitrile butadiene styrene (“ABS”) and polycarbonate ABS (“PC-ABS”). The NIR spectrometer 192 is a device that measures properties of NIR light (800 nm to 2500 nm wavelength) applied to a sample material, such as a portion of the dark-colored plastics 191, to identify the material. In this exemplary embodiment, the NIR spectrometer 192 uses light energy in the wavelength range of 1000 nm to 2200 nm. Measurements from the NIR spectrometer 192 are compared to pre-defined reference measurements for HIPS materials to identify and recover any HIPS materials 193 in the dark-colored plastics. For example, NIR light is reflected off the dark-colored plastic and the reflected light characteristics are compared to light reflected off a HIPS reference material. Qualitative analyses are sufficient to identify HIPS from non-HIPS materials.

In step 255, another NIR spectrometer 196 processes the light-colored plastics to separate and recover HIPS 198 from non-HIPS materials 199, such as ABS. Like the NIR spectrometer 192, the NIR spectrometer 196 is an optical device that measures properties of NIR light applied to a sample material, such as a portion of the light-colored plastics, to identify the material. Measurements from the NIR spectrometer 196 are compared to pre-defined reference measurements for HIPS materials to identify and recover any HIPS materials 198 in the light-colored plastics.

Steps 260, 265, and 270 are depicted on FIG. 2b, which is a continuation of process 200. In step 260, the metal materials detected by the dynamic sensor 172 in step 240 are processed by an optical sorter 176, which separates printed circuit board materials 178 from non-printed circuit board materials. Like the optical sorters 158 and 176, the optical sorter 176 includes one or more optical devices, such as cameras, which are operable to detect the color of a material. In certain exemplary embodiments, the optical sorter 176 identifies green items in the metal materials 174 as printed circuit board materials 178 and non-green items in the metal materials 176 as non-printed circuit board materials. The printed circuit board materials 178 are recovered in step 265.

The non-printed circuit board materials are processed in step 270 to separate and recover stainless steel 186 and wire materials 184, using an analog sensor 182. An analog sensor 182, also known as an inductive sensor, is a device that detects the presence of metallic objects based on the amount (or magnitude) of current produced in an inductive loop. For the analog sensor 182 to indicate that a metallic object is present, the current generated in the inductive loop must reach a specified minimum level (threshold) and remain above that threshold for a specified time interval, called the debounce, before the digital output from the sensor 182 is turned on. This digital output is an indication of the presence of a metallic object in the monitored material. The digital output is held in the on position until the inductive loop current drops back below the threshold. The threshold may be determined such that the sensor 182 has different outputs for stainless steel 186 and wire materials 184, allowing those materials 186 and 184 to be separated and recovered.

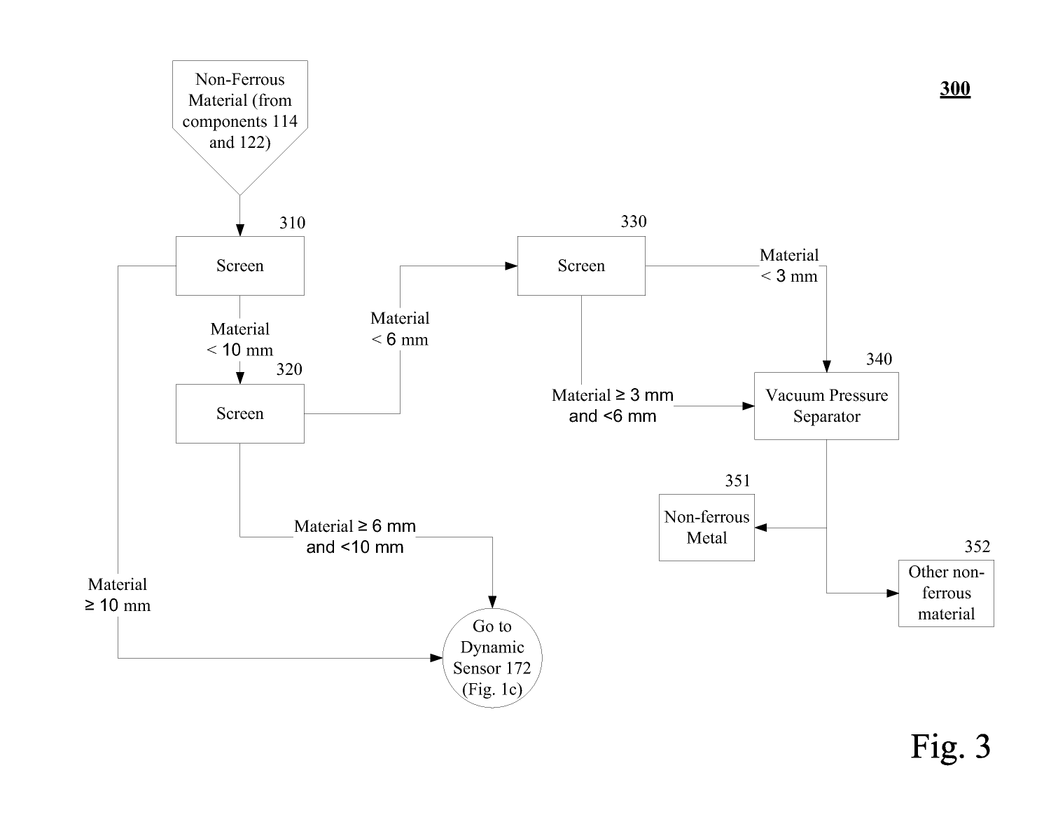

FIG. 3 depicts an alternative method 300 for processing non-ferrous materials separated from the electronic waste stream 102 by ferrous separator #1 114 and ferrous separator #2 122. Referring to FIGS. 1a, 1c, 2a, and 3, in an alternative embodiment, the portion of the process 100 depicted in FIG. 1b can be replaced with the method 300, depicted in FIG. 3. Non-ferrous material separated at step 210 by ferrous separator #1 114 and ferrous separator #2 122 is processed by three screens 310, 320, 330 to separate the non-ferrous materials by size. The screen 310 separates material into material with a size greater than or equal to 10 mm and material with a size less than 10 mm. Typically, the material will be no larger than 15 mm but could be as large as 40 mm of larger. The upper bound on this size range may be determined by the size reduction processes employed prior to separating the ferrous material from the non-ferrous material in the incoming electronic waste stream 102.

Material that is greater than or equal to 10 mm in size is processed by a dynamic sensor such as the dynamic sensor 172 to generate a metallic fraction and a non-metallic fraction (primarily plastic), substantially as described above in connection with step 240 of FIG. 2a. Material that is less than 10 mm in size is processed by the screen 320. The screen 320 separates material into material with a size greater than or equal to 6 mm, but less than 10 mm in size, and material with a size less than 6 mm.

Material that is greater than or equal to 6 mm, but less than 10 mm in size is processed by a dynamic sensor such as the dynamic sensor 172 to generate a metallic fraction and a non-metallic fraction (primarily plastic), substantially as described above in connection with step 240 of FIG. 2a. Typically, this material would be processed separately from the material that is greater than or equal to 10 mm in size. This separate processing may be accomplished by processing the separate materials in separate batches using the same dynamic sensor or by processing the separate materials using different dynamic sensors. The dynamic sensor that processes the material that is greater than or equal to 6 mm, but less than 10 mm in size may be configured differently to process the different sized material. Material that is less than 6 mm in size is processed by the screen 330. The screen 330 separates material into material with a size greater than or equal to 3 mm, but less than 6 mm, and material with a size less than 3 mm.

The material with a size greater than or equal to 3 mm, but less than 6 mm in size, is further processed with a vacuum pressure separator 340. The vacuum pressure separator 340 operates like a destoner. The vacuum pressure separator 340 separates dry, granular materials into two specific weight fractions—a heavy fraction and a light fraction. Typically, the vacuum pressure separator 340 includes a screen on a deck. Material is vibrated on the deck as air moves up through the screen. The light fraction is entrained in the air stream while the heavy fraction is not. A typical destoner is the Forsberg P-Series Destoner, made by Forsberg, Inc.

The material is separated into a non-ferrous metal 351 fraction and an other non-ferrous material 352 fraction, which would contain plastic material. The non-ferrous metal 351 fraction would be the “heavy” fraction from the vacuum pressure separator 340 and the non-ferrous material 352 fraction would be the “light” fraction from the vacuum pressure separator 340. Alternatively, the material with a size greater than or equal to 3 mm, but less than 6 mm could be processed in a dynamic sensor to separate non-ferrous metals from other non-ferrous material.

The material with a size less than 3 mm is also further processed with a vacuum pressure separator 340. Typically, this material would be processed separately from the material with a size greater than or equal to 3 mm, but less than 6 mm. This separate processing could be accomplished using a batch process and the same vacuum pressure separator 340 of by using two vacuum pressure separators 340. The non-ferrous metal 351 fraction would be the “heavy” fraction from the vacuum pressure separator 340 and the non-ferrous material 352 fraction would be the “light” fraction from the vacuum pressure separator 340.

One of ordinary skill in the art would appreciate that the invention is directed to cost-effective, efficient methods and systems for recovering materials from a waste stream. In particular, the invention is directed to systems and methods for separating and recovering like-type materials from an electronic waste stream. The recovered materials can include, without limitation, ferrous and non-ferrous metals and plastics. Also, printed circuit board materials and precious metals can be recovered.

Although specific embodiments of the invention have been described above in detail, the description is merely for purposes of illustration. It should be appreciated, therefore, that many aspects of the invention were described above by way of example only and are not intended as required or essential elements of the invention unless explicitly stated otherwise. Various modifications of, and equivalent steps corresponding to, the disclosed aspects of the exemplary embodiments, in addition to those described above, can be made by a person of ordinary skill in the art, having the benefit of this disclosure, without departing from the spirit and scope of the invention defined in the following claims, the scope of which is to be accorded the broadest interpretation so as to encompass such modifications and equivalent structures.

What is claimed:

1. A method for separating materials from an electronic waste stream comprising the steps of:
receiving the electronic waste stream comprising ferrous material and non-ferrous material;
separating the received electronic waste stream into a ferrous material fraction comprising at least a portion of the ferrous material and a non-ferrous material fraction comprising at least a portion of the non-ferrous material by removing the ferrous material fraction using the magnetic characteristic of the ferrous material comprising the ferrous material fraction;
further separating the non-ferrous material fraction into a non-ferrous metal fraction and an other non-ferrous material fraction using an eddy current separator; and
recovering a zorba material from the non-ferrous metal fraction by separating a printed circuit board material from the non-ferrous metal fraction using an optical sorter.

2. The method of claim 1 further comprising the step of separating the non-ferrous material fraction into a larger fraction and a smaller fraction prior to separating the non-ferrous material fraction into a non-ferrous metal fraction and an other non-ferrous material fraction, wherein the larger fraction comprises material of a larger size than the material comprising the smaller fraction and wherein the average particle size of the material in the larger fraction is 2 millimeters.

3. The method of claim 2 wherein the larger fraction is processed by the eddy current separator but the smaller fraction is not.

4. The method of claim 1 further comprising the steps of:
separating the other non-ferrous material fraction into a plastic material fraction and a metals material fraction using a dynamic sensor; and
separating any high-impact polystyrene plastic from the plastic material fraction using a near infrared spectrometer.

5. The method of claim 4 further comprising the step of separating printed circuit board material from the metal materials fraction.

6. The method of claim 4 further comprising the step of separating the plastic material into a light-colored plastic material fraction and a dark-colored plastic material fraction prior to separating any high-impact polystyrene plastic from the plastic material.

7. The method of claim 1 further comprising the steps of:
separating the ferrous material fraction by weight into a light fraction and a heavy fraction using an air separator; and
recovering any precious metals from the light fraction using a cyclone.

8. The method of claim 7 further comprising the step of separating the heavy fraction into clean ferrous materials and dirty ferrous materials.

9. A method for separating materials from an electronic waste stream comprising the steps of:
receiving the electronic waste stream comprising ferrous and non-ferrous material;
separating the received electronic waste stream into a ferrous material fraction comprising at least a portion of the ferrous material and a non-ferrous material fraction comprising at least a portion of the non-ferrous material by removing the ferrous material fraction using the magnetic characteristic of the ferrous material comprising the ferrous material fraction;
further separating the ferrous material fraction into a heavy fraction and light fraction using an air separator; and
recovering any precious metal from the light fraction.

10. The method of claim 9 further comprising the step of separating the heavy fraction into clean ferrous materials and dirty ferrous materials

11. The method of claim 9 further comprising the steps of:
screening the non-ferrous material fraction to separate the material by size; and
separating the screened non-ferrous material fraction into a non-ferrous metal fraction and an other non-ferrous material fraction.

12. The method of claim 11 wherein the screening step comprises screening the non-ferrous material fraction into more than two size ranges.

13. The method of claim 11 wherein the separating step comprises employing a dynamic sensor.

14. The method of claim 11 wherein the separating step comprises employing a vacuum pressure separator.

15. The method of claim 11 further comprising the step of separating any high-impact polystyrene plastic from the other non-ferrous material fraction using a near infrared spectrometer.

16. The method of claim 15 further comprising the step of separating the other non-ferrous material fraction into a light-colored plastic material fraction and a dark-colored plastic material fraction prior to separating any high-impact polystyrene plastic from the other non-ferrous material fraction.

17. The method of claim 11 further comprising the step of separating printed circuit board material from the non-ferrous metals fraction.

18. The method of claim 9 wherein the step of recovering any precious metals from the light fraction comprises using a cyclone.

19. A system for separating materials from an electronic waste stream material comprising:
a size reducer operable to reduce the size of the electronic waste stream material;
a ferrous material separator, operable to separate ferrous material from the size-reduced electronic waste stream material, resulting in a ferrous material fraction and a non-ferrous material fraction;
an air separator operable to separate the ferrous material fraction into a light fraction and a heavy fraction; and
a cyclone operable to separate precious metal from the light fraction.

20. The system of claim 19 further comprising an eddy current operable to separate the non-ferrous material fraction into a non-ferrous metals fraction comprising a zorba material and a printed circuit board material and a other non-ferrous materials fraction.

21. The system of claim 20 further comprising a screen operable to separate the non-ferrous fraction by size.

22. The system of claim 21 further comprising a dynamic sensor operable to sort a non-ferrous metal fraction and a other non-ferrous material fraction from the sized non-ferrous material fraction.

23. The system of claim 21 further comprising a vacuum pressure separator operable to sort a non-ferrous metal fraction and a other non-ferrous material fraction from the sized non-ferrous material fraction.

24. The system of claim 20 further comprising an optical sorter operable to separate the zorba material from the printed circuit board material.

25. The system of claim 20 further comprising:
an air separator operable to separate the other non-ferrous materials fraction into a light fraction and a heavy fraction;
a dynamic sensor operable to sort a metal fraction and a plastic fraction from the heavy fraction; and
a near infrared spectrometer operable to identify high impact poly styrene plastic in the plastic fraction.
